(19) United States
(12) Patent Application Publication
(10) Pub. No.: US 2021/0102387 A1
(43) Pub. Date: Apr. 8, 2021

(54) Rubber flooring and method for producing rubber flooring for heavy animal maintenance and care facilities

(71) Applicant: Joseph Grubic, Waco, TX (US)

(72) Inventor: Joseph Grubic, Waco, TX (US)

(21) Appl. No.: 17/063,200

(22) Filed: Oct. 5, 2020

Related U.S. Application Data
(60) Provisional application No. 62/911,839, filed on Oct. 7, 2019.

(51) Int. Cl. E04F 15/18; C04B 41/48; C04B 41/53; C09D 175/04; C09D 163/00; C04B 41/63; C04B 41/72; A01K 1/01; A01K 1/015

(52) U.S. Cl. CPC E04F 15/181; C04B 41/4853; C04B 41/5346; C09D 175/04; E04F 2290/044; C04B 41/63; C04B 41/72; A01K 1/0103; A01K 1/015; C09D 163/00

(57) ABSTRACT

A encapsulation system incorporating a polymer repair mixture with quartz sand that enables an underlying monolithic membrane to fully encapsulate an entire mat into a concrete surface allowing for resilient bond which holds up to the weight and force of Rhinoceros, Hippopotamus, Giraffe and Elephants. Use of such durable flooring of the present invention may be suitable to a diverse array of situations requiring a hard-wearing material, such as zoos, veterinary hospitals, animal transport trailers, quality stall systems, healthcare, arena footing, supermarkets, gymnasiums and schools, as well as other commercial, institutional and sporting uses.

### STATEMENT OF PROVISIONAL APPLICATION

This application claims the benefit of priority to U.S. Provisional Application No. 62/911,839 filed on Oct. 7, 2019, the entire contents of which are hereby incorporated by reference.

### BACKGROUND

### Field

Improved flooring surfaces, and in particular to a flooring and methods for producing flooring surfaces for care and protection of hooved animals, and others for which rigid surfaces are health-endangering.

### Background

The floor or ground surfaces upon which an animal regularly stands or walks have immediate and long-term effects on both the animals and the people who care for them. This is particularly true for the large, hooved animals, such as giraffes, elephants, and the like. Such animals, that typically weigh much more than the average person pose unique problems when constructing suitable flooring. Flooring which is adequate for people, may not be so for animals, either from an animal health standpoint, or from a durability standpoint.

Concrete and other smooth, hard flooring for various animal environment, e.g., zoos, lactating barns for cows, horse and cattle trailers, etc., have been around for many years. However, such flooring poses many immediate and long-term problems for the animals, especially heavy animals in a high traffic area.

Hard (substantially non-resilient) and smooth concrete surfaces allow for even weight distribution across the entire area where the animal, e.g., hoof, contacts the surface. However, constant repetitive contact on hard, unforgiving and even surfaces can cause a host of injuries, e.g., swollen hocks or knees, mastitis, solar ulcers, etc. Likewise, constant repetitive contact on hard, unforgiving and uneven surfaces can also cause an array of animal injuries, e.g., damage to the internal components of the hoof. Over time, these injuries can compromise the overall health and attractiveness of irreplaceable animals. The Association of Zoos and Aquariums reports there are 215 accredited zoos in 45 U.S. states, hosting over 195 million visitors annually. These visits reportedly contributed $22.5B to the U.S. economy in 2016 and provided over 200,000 jobs. Of the 6000 species found in zoos across the country, many are members of threatened or endangered species.

Concrete floors are notorious for being slippery, especially when wet or with the presence of animal feces. Such slippery concrete surfaces cause injury or loss of life, to both human caretakers and animals, often at an alarming rate. Grooving concrete can be beneficial to provide lateral stability on that surfaces that would be slippery, but does very little for normal locomotion and footing. Proper animal locomotion and animal safety, not to mention other daily activities, require good and proper traction. Concrete flooring can be re-grooved, as needed, but this does not solve the aforementioned problems.

Scabbling concrete floors with a concrete planer (rotating knives moving laterally to cut the concrete) is another alternative, but the resulting flooring has ridges and points from the inconsistent depth of the cut. These ridges and points create palpable pressure points, which means the animals can feel such uneven ridges. Thus, as a result of the animal's weight being concentrated on certain high points of the floor, the foot may experience discomfort, pain and long-term injury.

Rubber flooring is the benchmark for durability and safety in the large animal flooring context. Not only does rubber flooring as presently used in zoos and the like provide both the smooth and resilient surface that best serve heavy animals' needs, it is one of the few materials that can be effectively disinfected and is free of toxicity. Also, such flooring can be easily cleaned.

Presently, rubber flooring for animal holding and passage areas is installed through a highly time-consuming and costly process. Thin layers of rubber-containing compounds are applied, one after the other, until the desired thickness is achieved. Each layer must be allowed to adequately cure before moving to the application of the next layer.

This process requires the delivery of many different chemicals and ingredients to a remote job sight, special preparation of the chemical's ingredients by special equipment and methodology, and involves many workers who must be especially skilled in the process. As a result, rubber flooring as is currently known in the zoo and related contexts, is so expensive, that this beneficial tool for animal care is often foregone, out of shear budgetary necessity.

The use of rubber mats to replace the layered rubber flooring described above may seem to be a logical alternative. However, mats tend to shift, thereby creating ridges against which animals or people may stumble. Thus, mats that can move pose a significant risk of injury to both animals and caretakers by creating a fall hazard. The Journal of Zoo and Wildlife Medicine reports that 60% of veterinarians have fallen, with 60% of those who fall sustaining back injuries. In addition, many animals will chew the exposed edges of rubber mats, a considerable danger to their health.

Furthermore, many rubber mats are simply not of the desirable resilience for heavy animals. A mat that is too soft may feel good to the touch but typically lacks in durability and longevity. (For example, research shows that milk production increases significantly when a cow is comfortable when lying down.) Soft rubber matting can also cause torsion injuries to animals, including, for examples, pasterns, knees and stifles.

Re-adjusting shifted mats or replacing worn out rubber mats requires zoo caretakers to enter enclosures. Each entry into an enclosure is an opportunity for a dangerous interaction between animal and human to occur. The vice-president for animal health and senior veterinarian at the Philadelphia Zoo, Dr. Keith Hinshaw, reports that elephants are the most dangerous, having killed more handlers than any other animal.

### DESCRIPTION OF THE PRIOR ART

Prior issued patents which relate to rubber flooring in general include the following: U.S. Pat. No. 6,689,239 issued Feb. 10, 2004 to Joe Grubic describes applying a rubber-like flooring to an existing concrete surface comprising the encapsulation of rubber mats. That invention was inadequate to meet demands of the environment, requiring extensive repair on all floors the invention was applied to.

### SUMMARY

In view of the foregoing, it would be well-serve those who care for heavy animals, as well as the animals themselves, to provide an alternative flooring material and/or method for producing flooring material, the use or practice of which provides a near-identical flooring surface (exhibiting the desired degree of resilience, durability, and ease of cleaning) at a cost which is within the reach of most all who care for animals (in fact, less than the long-term veterinary expense arising from using concrete flooring instead).

It is anticipated that embodiments of the invention disclosed herein will greatly facilitate delivery of such an alternative floor that provides both near ideal flooring that has the desired degree of resilience, durability, and ease of cleaning without being cost prohibitive. It is anticipated that the best embodiment of the encapsulating method involves application to a new, depressed concrete slab that has cured to allow no more than 80% relative humidity over 72 hours. If restricted to application on an existing slab the preferred embodiment would be application of the invention to the slab after shot blasting or diamond grinding of the concrete surface.

It is, therefore, expected that embodiments of the present invention will provide a reliable and effective alternative to concrete flooring for heavy and high animal traffic areas, like in zoos.

Such embodiments are expected to further, more specifically expected to provide a novel and unobvious rubber flooring for heavy and high animal traffic areas.

Such embodiments are expected to further, more specifically expected to provide a more efficient method of producing rubber flooring than the current process of pouring multiple layers of rubber over a period of time.

Such embodiments are expected to further, more specifically expected to provide a very cost-effective, yet equally beneficial alternative to present rubber flooring as is used in animal maintenance and care facilities.

Such embodiments are expected to further, more specifically expected to provide a safe flooring for animal locomotion whereby there are no edges to trip or loose footing thereof.

Such embodiments are expected to further, more specifically expected to provide a method for encapsulating rubber mats to produce a better alternative to current rubber flooring, especially in the context of high traffic of heavy animals.

In satisfaction of the above expectations, known embodiments of the present invention do, in fact, provide an improved rubber flooring and method for producing same which is both cost effective and of superior performance characteristics in the context of animal care and maintenance facilities. The flooring is comprised of rubber mats which are encapsulated in substantially the same rubber-containing compounds as are now used to produce rubber flooring by conventional methods. However, because much of the volume of a floor produced according to the present method is occupied by the already-formed rubber mat, the time to install the flooring is substantially reduced, and with it the costs of labor, installation materials, and equipment usable.

Once a floor is produced according to the present invention, it provides indistinguishable characteristics and performance from that of existing rubber floor installations. The cost-effective nature of the flooring and method of the present invention is such that uses, previously ruled out because of cost considerations, may now be added. Such would include uses in even inexpensive horse and cattle trailers, just to give one example.

Through use of the presently described product and associated methods, the present inventor has successfully and drastically reduced the actual square foot cost of current rubber flooring from approximately $30 to $4.00 per square foot—a significant reduction in rubber flooring expense.

The cost savings alone from use of the method and application of the present invention will easily exceed millions of dollars each year for zoos and other animal care facilities.

Reclamation of ten used passenger tires are required to make one 4×6¾″ mat. Thus, about 500 worn out passenger tires would be reclaimed when installing 1000 sq. ft. of flooring rather than ending up in a landfill.

### BRIEF DESCRIPTION OF THE DRAWINGS

FIG. 1 Cross section of the preferred embodiment for new construction.

FIG. 2 Cross section of the preferred embodiment for existing concrete slabs.

FIG. 3 Cross section of the layers in the rubber flooring. Thickness for the layers is not true to scale. The respective thickness of the preferred embodiment are approximately: 2 ml of primer epoxy (layer 14 and 17), 1/16″ for the monolithic base coat (layer 13 and 16), ¾″ for the preformed rubber mat (layer 15), 0.05 to 1.5 mm for the rubber granules (layer 12), and 12 ml for the top coat (layers 10 and 11).

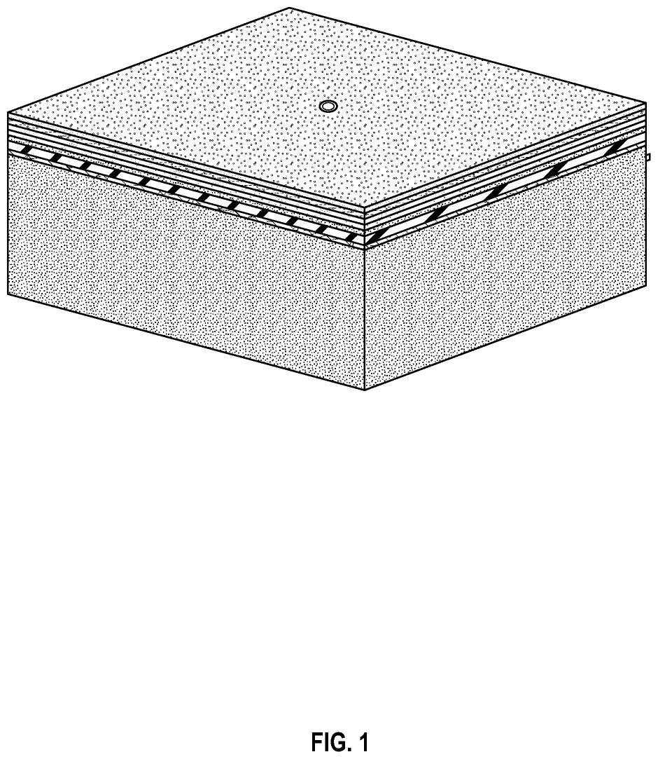

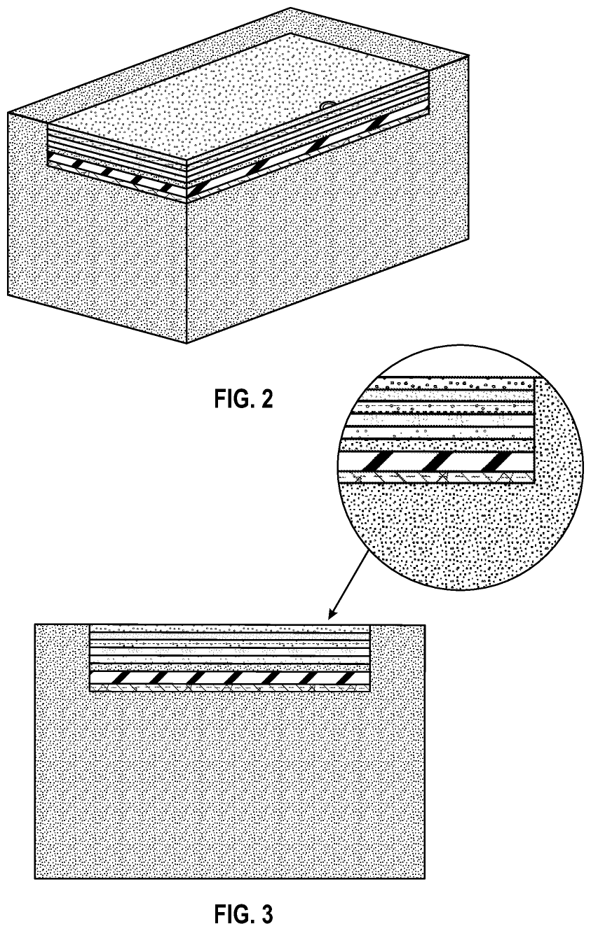

### DETAILED DESCRIPTION OF AN EMBODIMENT FOR NEW CONSTRUCTION

The rubber flooring system should not be installed over new concrete until the concrete has cured to allow no more than 80% relative humidity over 72 hours. The concrete sub floor is depressed ¾″ and drains are elevated ¾″ with adequate slope to the drain to accommodate the flooring system. The concrete subfloor should be clean, dry, free from sealer, drying agents, curing or parting compounds. The slab should be finished with an 80 grit (light broom) Finish. A ⅛″ pre-molded membrane should be installed below the concrete slab.

A primer coat of epoxy is then rolled over the concrete. After the epoxy cures (approximately 3-5 hours) apply an elastomeric polyurethane membrane with either a ¼″ serrated squeegee or a ¼″ serrated trowel to a settling level of 1/16″ to ⅛″ in thickness. (c). Place the precut rubber mats are over the wet elastomeric polyurethane membrane coat at a distance between 1/16″ and ⅛″ to the next mat and then roll with a turf roller.

Next, prepare an elastomeric polyurethane membrane coat sand mixture, which, for the present application, is a mixture of: (1) elastomeric polyurethane membrane solvent free base and water (elastomeric polyurethane membrane base 4 parts and water 1 part by volume); and (2) equal volume of sand.

Pour this elastomeric polyurethane membrane base and sand between the gaps of the mats.

Prime the top surface of the mats with an epoxy mixture of resin and cure until it sets up to a tacky point.

Next, float an encapsulating elastomeric polyurethane membrane mixture (without sand) over the mats to within a thickness of 1/16″ to ⅛″ thickness. This encapsulating elastomeric polyurethane membrane mixture is comprised of four parts elastomeric polyurethane membrane to one-part water. After the encapsulating mixture is applied While still wet, one applies a thin layer of finely ground rubber particles sufficient to cover the surface. After this step, cure out takes 6 to 8 hours naturally, or approximately twice as fast using an accelerator. After cure out of the elastomeric polyurethane membrane base, remove by any means all loose, unbonded ground rubber. At this point, two coats of Aliphatic Urethane Sealer are applied, the second coat being applied after the first has dried.

### Description of an Embodiment for Existing Concrete Slabs

Prepare the concrete by shot blasting or diamond grinding the concrete surface to clean and profile the concrete surface.

A primer coat of epoxy is then rolled over the concrete. After it cures apply an elastomeric polyurethane membrane with either a ¼″ serrated squeegee or a ¼″ serrated trowel to a settling level of 1/16″ to ⅛″ in thickness. Leave a 3″ gap around outer edges of concrete slab. Place the precut rubber mats over the wet elastomeric polyurethane membrane coat at a distance between 1/16″ and ⅛″ to the next mat and then roll with a turf roller.

Next, prepare an elastomeric polyurethane membrane coat sand mixture, which, for the present application, is a mixture of: (1) elastomeric polyurethane membrane solvent free base and water (elastomeric polyurethane membrane base 4 parts and water 1 part by volume); (2) equal volume of sand; and (3) Then pour sand mixture between gaps in mats.

One-part polymer repair mortar+four parts Quartz Sand, pour mortar mixture around the 3″ outer edges of the mats and cove it an angle up to the top edge of the mat.

Prime the top surface of the mats, including the 3″ covered edges, with a mixture of resin and cure until it sets up to a tacky point.

Next, float an encapsulating elastomeric polyurethane membrane mixture (without sand) over the mats to within a thickness of 1/16″ to ⅛″ thickness. This encapsulating elastomeric polyurethane membrane mixture is comprised of four parts elastomeric polyurethane membrane to one-part water. After the encapsulating mixture is applied, one applies a thin layer of finely ground rubber particles sufficient to cover the surface. After this step, cure out takes 6 to 8 hours naturally, or approximately twice as fast using an accelerator. After cure out of the elastomeric polyurethane membrane base, remove by any means all loose, unbonded ground rubber. At this point, two coats of Aliphatic Urethane Sealer are applied, the second coat being applied after the first has dried.

1. Rubber flooring system comprising:
a concrete base;
a protective and elastic membrane;
a mat structure;
an elastomeric polyurethane membrane coat sand mixture; and
encapsulating elastomeric polyurethane membrane mixture.

2. The rubber flooring system of claim 1 wherein said protective and elastic membrane is an elastomeric polyurethane membrane.

3. The rubber flooring system of claim 2 wherein said mat structure is a precut rubber mat.

4. The rubber flooring system of claim 3 wherein said concrete base has cured.

5. The rubber flooring system of claim 4 wherein said concrete base is depressed and drains are elevated with slope.

6. The rubber flooring system of claim 5 wherein said concrete base is primed with a coat of epoxy.

7. The rubber flooring system of claim 3 wherein said concrete base is an existing concrete slab.

8. The rubber flooring system of claim 7 wherein said existing concrete slab is prepared by shot blasting or diamond grinding the concrete surface.

9. The rubber flooring system of claim 3 wherein said elastomeric polyurethane membrane is applied with a serrated squeegee or serrate trowel.

10. The rubber flooring system of claim 3 wherein said precut rubber mats are placed over the said elastomeric polyurethane membrane layer while said elastomeric polyurethane membrane layer is still wet.

11. The rubber flooring system of claim 10 wherein said precut rubber mats are placed at a distance between 1/16″ and ⅛″ to the next rubber mat.

12. The rubber flooring system of claim 11 wherein said precut rubber mats are rolled with a turf roller.

13. The rubber flooring system of claim 3 wherein said elastomeric polyurethane membrane coat sand mixture comprising:
elastomeric polyurethane membrane solvent free base and water; and
equal volume of sand.

14. The rubber flooring system of claim 13 wherein said elastomeric polyurethane membrane solvent free base and water comprising:
4 parts elastomeric polyurethane membrane base; and
1 part water by volume.

15. The rubber flooring system of claim 13 wherein said elastomeric polyurethane membrane coat sand mixture is poured between the gaps of the said precut rubber mats.

16. The rubber flooring system of claim 15 wherein the top surface of the precut rubber mats are primed with an epoxy mixture.

17. The rubber flooring system of claim 3 wherein said encapsulating elastomeric polyurethane membrane mixture comprising:
4 parts elastomeric polyurethane membrane; and
1 part water by volume.

18. The rubber flooring system of claim 17 wherein said encapsulating elastomeric polyurethane membrane mixture is applied over the said precut rubber mats.

19. The rubber flooring system of claim 18 wherein a layer of ground rubber particles is applied to top surface of said encapsulating elastomeric polyurethane membrane mixture.

20. The rubber flooring system of claim 19 wherein one or more coats of sealer is applied to the top surface of said layer of ground rubber particles.
